(19) United States
(12) Patent Application Publication
(10) Pub. No.: US 2007/0292662 A1
(43) Pub. Date: Dec. 20, 2007

(54) Three-dimensional exterior camouflage article and method

(76) Inventor: Steve M. Johnson, Church Hill, TN (US)

Correspondence Address: S. Michael Bender, P.O. Box 530-399, St. Petersburg, FL, 33747, US

(21) Appl. No.: 11/155,115

(22) Filed: Jun. 17, 2005

(51) Int. Cl. B44C 1/17

(52) U.S. Cl. 428/195.1

(57) ABSTRACT

Camouflage articles and a method of making three-dimensional exterior camouflage articles are provided. The method includes the steps of: obtaining a two-dimensional photograph of an exterior surface of a portion of a living organism, digitizing the two-dimensional photograph into a two-dimensional digital data set, processing the two-dimensional digital data set into a three-dimensional digital data set by using a computer program in a digital computer, obtaining a noncamouflage material, and employing the three-dimensional digital data set for modifying the exterior surface of the noncamouflage material to produce the three-dimensional exterior camouflage article. The three-dimensional digital data set can be employed for driving a laser cutting tool for cutting the exterior surface of the noncamouflage material to produce the three-dimensional exterior camouflage article.

### BACKGROUND OF THE INVENTION

1. Field of the Invention

The present invention relates generally to camouflage articles, and, more particularly, to camouflage articles that have a three-dimensional exterior surface.

2. Description of the Prior Art

The use of camouflage is well known in the arts of hunting and in the military arts. For example, camouflage cloth is used in the fabrication of clothing. Also, painted camouflage patterns are used for the exterior surfaces of vehicles and buildings.

Clothing and painting patterns that employ camouflage are essentially two-dimensional camouflage patterns. For more realism, however, it would be desirable if camouflage articles could have three-dimensional exterior camouflage surfaces. Aside from visual realism, a three-dimensional exterior camouflage surface would provide a tactile surface that a user, such as a hunter or soldier, could feel in the dark. In this respect, it would be desirable to provide a three-dimensional tactile surface that a user can feel in the dark.

An underlying principle of camouflage is for an out-of-place article to simulate the appearance of articles that are normally found in the place. In this way, the camouflaged article blends in with its background and environment; and by blending in with the background and environment, the camouflaged article is not noticeable. With this principle in mind, it would be desirable if a simulated exterior surface of a living organism, such as a plant or animal, could be applied to the exterior surface of an article to provide a camouflaged article.

One implement of a hunter or soldier that often lacks a camouflaged exterior surface is a firearm, for example, a shotgun or rifle. In this respect, it would be desirable to provide a camouflaged exterior surface for a firearm.

With respect to a shotgun or rifle, the major exterior surfaces are comprised of the exterior surface of the firearm butt and the exterior surface of the firearm foreend. In this respect, it would be desirable to provide a three-dimensional camouflaged exterior surface for a firearm butt and for a firearm foreend.

Thus, while the foregoing discussion indicates it to be well known to use two-dimensional camouflaged articles, the discussion above does not teach or suggest a prior teaching of a three-dimensional exterior camouflage article and method which have the following combination of desirable features: (1) provide camouflage articles having three-dimensional exterior camouflage surfaces; (2) provide a three-dimensional tactile surface that a user can feel in the dark; (3) provide a simulated exterior surface of a living organism, such as a plant or animal, which can be applied to the exterior surface of an article to provide a camouflaged article; (4) provide a camouflaged exterior surface for a firearm; and (5) provide a three-dimensional camouflaged exterior surface for a firearm butt and for a firearm foreend. The foregoing desired characteristics are provided by the unique three-dimensional exterior camouflage article and method of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a method of making a three-dimensional exterior camouflage article includes the steps of:
obtaining a two-dimensional photograph of an exterior surface of a portion of a living organism,
digitizing the two-dimensional photograph into a two-dimensional digital data set,
processing the two-dimensional digital data set into a three-dimensional digital data set by using a computer program in a digital computer,
obtaining a noncamouflage material, and
employing the three-dimensional digital data set for modifying the exterior surface of the noncamouflage material to produce the three-dimensional exterior camouflage article.

The two-dimensional digital data set can be based upon data from a digital camera that is connected to the digital computer.

Also, the two-dimensional digital data set can be based upon data provided by the steps of: scanning a two-dimensional photographic print by a digital scanner; and transferring data based upon the scanning of the two-dimensional photographic print to the digital computer.

The three-dimensional digital data set can be employed for driving a cutting tool for cutting the exterior surface of the noncamouflage material to produce the three-dimensional exterior camouflage article. The cutting tool can be a laser cutting tool.

The portion of the living organism can be a moth wing. Alternatively, the portion of the living organism can be tree bark.

The computer program can differentiate between data representing light areas in the photograph and data representing dark areas in the photograph, and the computer program can transform data representing light areas into data representing elevations and can transform data representing dark areas into data representing depressions to form the three-dimensional digital data set which includes both data representing elevations and data representing depressions.

The noncamouflage material can be a noncamouflage firearm butt to produce a camouflage firearm butt. Also, the noncamouflage material can be a noncamouflage firearm foreend to produce a camouflage firearm foreend. In addition, the noncamouflage material can be a noncamouflage unified and integrated combination firearm butt and firearm foreend to produce a unified and integrated camouflage combination firearm butt and firearm foreend.

Also, the three-dimensional digital data set can be employed for making a reverse camouflage mold, and the reverse camouflage mold can be employed for molding the exterior surface of the noncamouflage material to produce the three-dimensional exterior camouflage article.

In accordance with another aspect of the invention, the subject invention also includes camouflage articles which include three-dimensional exterior camouflage surfaces. The camouflage articles include exterior surfaces that simulate portions of living organisms. One suitable portion of a living organism can be a moth wing. Another suitable portion of a living organism can be tree bark.

An article of the invention can be a camouflage firearm butt. Another article of the invention can be a camouflage firearm foreend. Still another article of the invention can be a unified and integrated camouflage combination firearm butt and firearm foreend.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved three-dimensional exterior camouflage article and method which has all of the advantages of the prior art and none of the disadvantages.

It is another object of the present invention to provide a new and improved three-dimensional exterior camouflage article and method which may be easily and efficiently manufactured and marketed.

It is a further object of the present invention to provide a new and improved three-dimensional exterior camouflage article and method which is of durable and reliable construction.

An even further object of the present invention is to provide a new and improved three-dimensional exterior camouflage article and method which is susceptible of a low cost of manufacture with regard to both materials and labor, and which accordingly is then susceptible of low prices of sale to the consuming public, thereby making such three-dimensional exterior camouflage article and method available to the buying public.

Still yet a further object of the present invention is to provide a new and improved three-dimensional exterior camouflage article and method which provide camouflage articles having three-dimensional exterior camouflage surfaces.

Still another object of the present invention is to provide a new and improved three-dimensional exterior camouflage article and method that provide a three-dimensional tactile surface that a user can feel in the dark.

Yet another object of the present invention is to provide a new and improved three-dimensional exterior camouflage article and method which provide a simulated exterior surface of a living organism, such as a plant or animal, which can be applied to the exterior surface of an article to provide a camouflaged article.

Even another object of the present invention is to provide a new and improved three-dimensional exterior camouflage article and method that provide a camouflaged exterior surface for a firearm.

Still a further object of the present invention is to provide a new and improved three-dimensional exterior camouflage article and method which provide a three-dimensional camouflaged exterior surface for a firearm butt and for a firearm foreend.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a photograph of a quantity of tree bark that can be used with the three-dimensional exterior camouflage article and method of the invention.

FIG. 2 is a block diagram of functional components for implementing the three-dimensional exterior camouflage article and method of the invention.

FIG. 3 is a side view of a firearm butt made in accordance with the principles of the three-dimensional exterior camouflage article and method of the invention.

FIG. 4 is a side view of a firearm foreend made in accordance with the principles of the three-dimensional exterior camouflage article and method of the invention.

FIG. 5 is a side view of a firearm that includes the firearm butt of FIG. 3 and the firearm foreend of FIG. 4 made in accordance of the invention.

FIG. 6 is a side view of an unified and integrated combination firearm butt and firearm foreend made in accordance of the invention.

FIG. 7 is a side view of a firearm which includes a unified and integrated combination firearm butt and firearm foreend of FIG. 6 of the invention.

### DESCRIPTION OF THE PREFERRED EMBODIMENT

With reference to the drawings, a new and improved three-dimensional exterior camouflage article and method embodying the principles and concepts of the present invention will be described.

A method of making a three-dimensional exterior camouflage article includes the steps of:
obtaining a two-dimensional photograph 11 of an exterior surface of a portion of a living organism,
digitizing the two-dimensional photograph into a two-dimensional digital data set,
processing the two-dimensional digital data set into a three-dimensional digital data set by using a computer program in a digital computer,
obtaining a noncamouflage material, and
employing the three-dimensional digital data set for modifying the exterior surface of the noncamouflage material to produce the three-dimensional exterior camouflage article.

The two-dimensional digital data set can be based upon data from a digital camera (not shown) that is connected to the digital computer.

Also, the two-dimensional digital data set can be based upon data provided by the steps of: scanning a two-dimensional photographic print by a digital scanner; and transferring data based upon the scanning of the two-dimensional photographic print to the digital computer.

The three-dimensional digital data set can be employed for driving a cutting tool 20 for cutting the exterior surface of the noncamouflage material to produce the three-dimensional exterior camouflage article. The cutting tool 20 can be a laser cutting tool 20.

The portion of the living organism can be a moth wing. Alternatively, the portion of the living organism can be tree bark.

The computer program can differentiate between data representing light areas in the photograph and data representing dark areas in the photograph, and the computer program can transform data representing light areas into data representing elevations and can transform data representing dark areas into data representing depressions to form the three-dimensional digital data set which includes data representing elevations and data representing depressions.

The noncamouflage material can be a noncamouflage firearm butt to produce a camouflage firearm butt 12. Also, the noncamouflage material can be a noncamouflage firearm foreend to produce a camouflage firearm foreend 14. In addition, the noncamouflage material can be a noncamouflage unified and integrated combination firearm butt and firearm foreend to produce a unified and integrated camouflage combination firearm butt and firearm foreend 16.

Also, the three-dimensional digital data set can be employed for making a reverse camouflage mold, and the reverse camouflage mold can be employed for molding the exterior surface of the noncamouflage material to produce the three-dimensional exterior camouflage article.

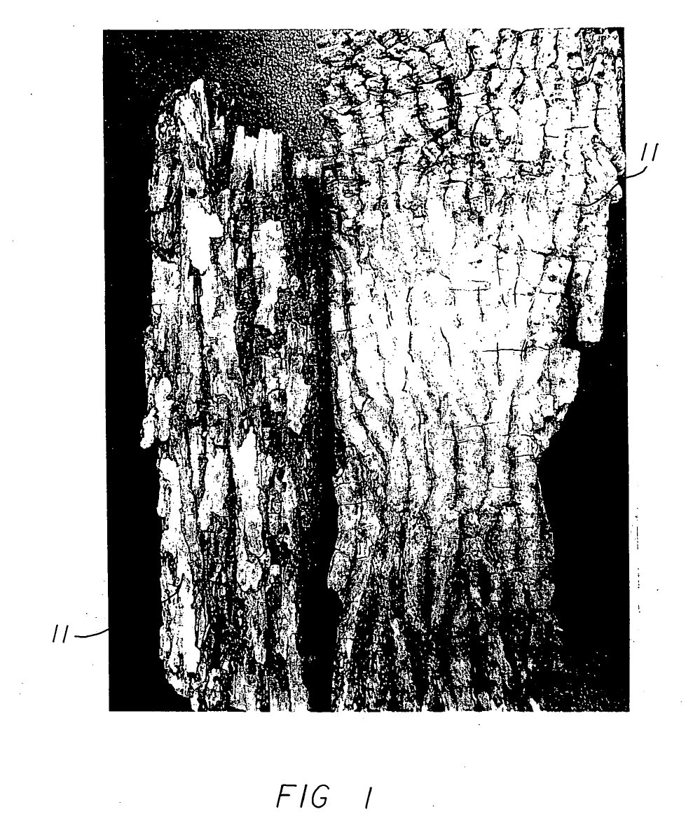

To carry out the method of the invention to produce the articles of the invention, a photograph 11 is taken of a living organism, such as the tree bark shown in FIG. 1. The photograph 11 can be taken for the express purpose of producing a camouflage article, or the photograph 11 can be any suitable photograph 11 that has been taken for any purpose. The photograph 11 can even be from a published book.

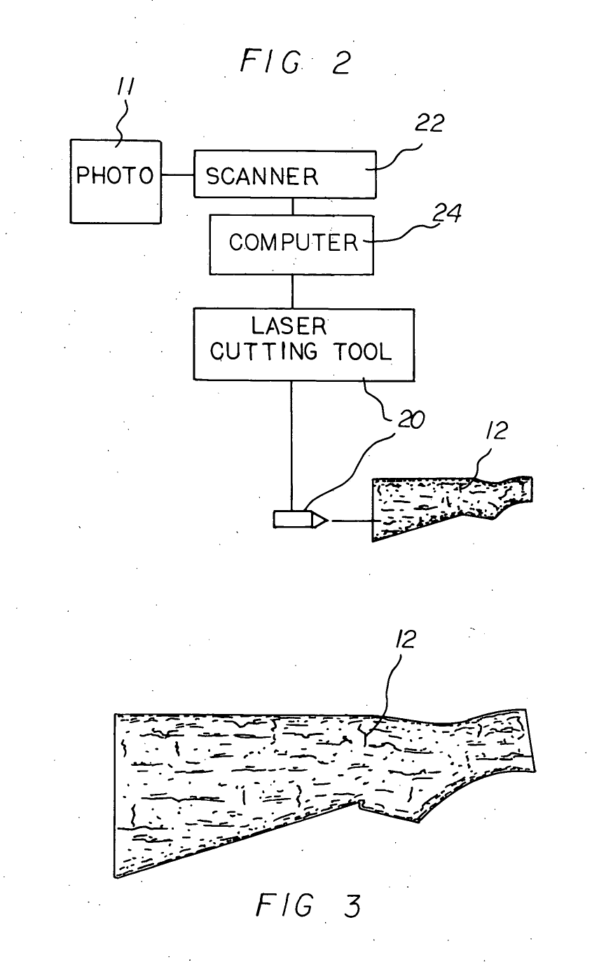

Then, with reference most specifically to FIG. 2, the photograph 11, such as a photographic print, is scanned by scanner 22 which transfers scanned data to the digital computer 24 to produce the two-dimensional digital data set. Then, the digital computer 24 processes the three-dimensional digital data set using a suitable computer program to produce the three-dimensional digital data set. Then, the three-dimensional digital data set is used to drive the laser cutting tool 20 which treats a noncamouflage firearm butt to produce the camouflage firearm butt 12 which has a three-dimensional exterior surface, such as shown in FIGS. 2, 3, and 5.

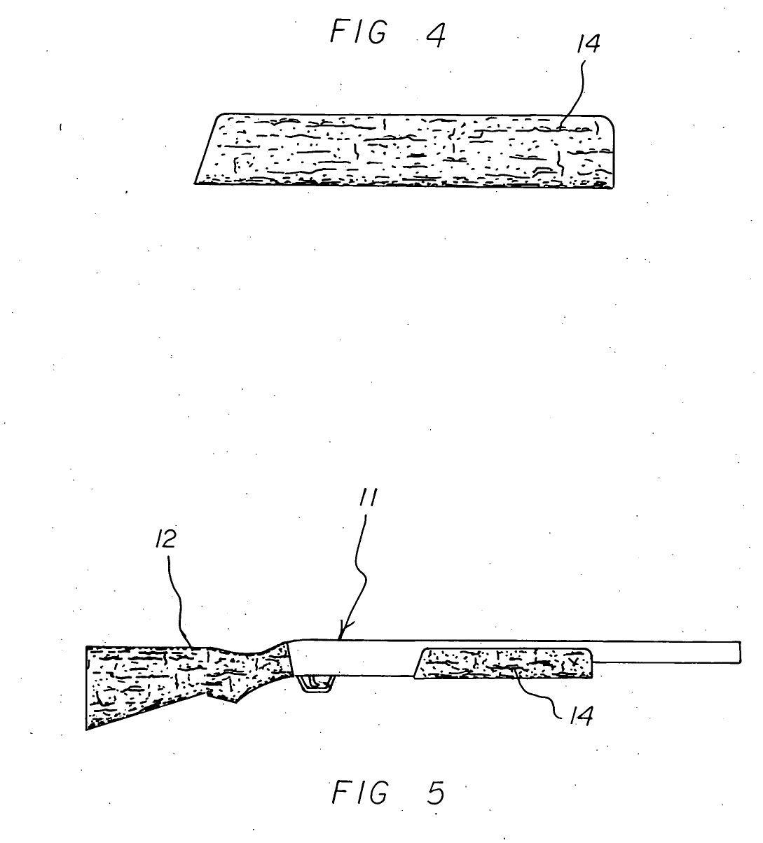

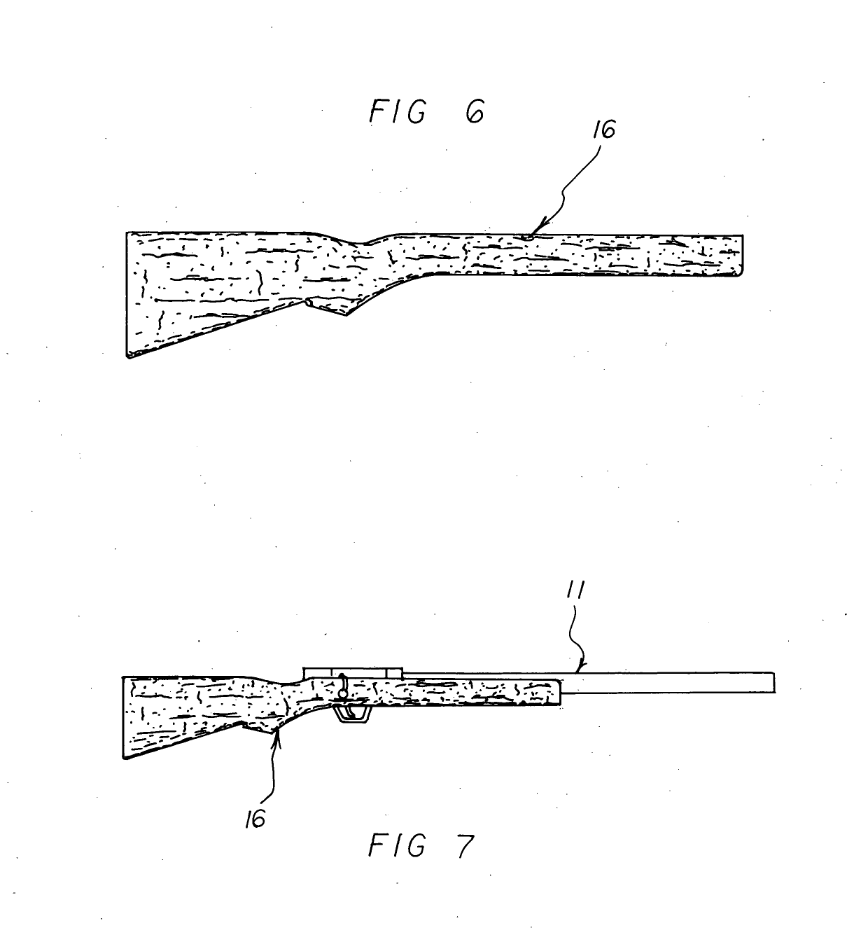

Instead of using a noncamouflage firearm butt, a noncamouflage firearm foreend can be used to produce a camouflage firearm foreend 14, as shown in FIGS. 4 and 5. Also, a unified and integrated noncamouflage combination firearm butt and firearm foreend can be used to produce a unified and integrated camouflage combination firearm butt and firearm foreend 16, as shown in FIGS. 6 and 7.

In accordance with another aspect of the invention, the subject invention also includes camouflage articles which include three-dimensional exterior camouflage surfaces. The camouflage articles include exterior surfaces that simulate portions of living organisms. One suitable portion of a living organism can be a moth wing. Another suitable portion of a living organism can be tree bark.

The article of the invention can be a camouflage firearm butt 12. The article of the invention can be a camouflage firearm foreend 14. The article of the invention can be a unified and integrated camouflage combination firearm butt and firearm foreend 16.

The components of the three-dimensional exterior camouflage article of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved three-dimensional exterior camouflage article and method that are low in cost, relatively simple in design and operation, and which may advantageously be used to provide camouflage articles having three-dimensional exterior camouflage surfaces. With the invention, a three-dimensional exterior camouflage article and method are provided which provide a three-dimensional tactile surface that a user can feel in the dark. With the invention, a three-dimensional exterior camouflage article and method are provided which provide a simulated exterior surface of a living organism, such as a plant or animal, which can be applied to the exterior surface of an article to provide a camouflaged article. With the invention, a three-dimensional exterior camouflage article and method are provided which provide a camouflaged exterior surface for a firearm. With the invention, a three-dimensional exterior camouflage article and method are provided which provide a three-dimensional camouflaged exterior surface for a firearm butt and for a firearm foreend.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A method of making a three-dimensional exterior camouflage article, comprising the steps of:
obtaining a two-dimensional photograph of an exterior surface of a portion of a living organism,
digitizing the two-dimensional photograph into a two-dimensional digital data set,
processing the two-dimensional digital data set into a three-dimensional digital data set by using a computer program in a digital computer,
obtaining a noncamouflage material,
employing the three-dimensional digital data set for modifying the exterior surface of the noncamouflage material to produce the three-dimensional exterior camouflage article.

2. The method of claim 1 wherein the two-dimensional digital data set is based upon data from a digital camera that is connected to the digital computer.

3. The method of claim 1 wherein the two-dimensional digital data set is based upon data provided by the steps of:
scanning a two-dimensional photographic print by a digital scanner; and
transferring data based upon the scanning of the two-dimensional photographic print to the digital computer.

4. The method of claim 1 wherein the three-dimensional digital data set is employed for driving a cutting tool for cutting the exterior surface of the noncamouflage material to produce the three-dimensional exterior camouflage article.

5. The method of claim 4 wherein the cutting tool is a laser cutting tool.

6. The method of claim 1 wherein the portion of the living organism is a moth wing.

7. The method of claim 1 wherein the portion of the living organism is tree bark.

8. The method of claim 1 wherein:
the computer program differentiates between data representing light areas in the photograph and data representing dark areas in the photograph, and
the computer program transforms data representing light areas into data representing elevations and transforms data representing dark areas into data representing depressions to form the three-dimensional digital data set which includes data representing elevations and data representing depressions.

9. The method of claim 1 wherein the noncamouflage material is a noncamouflage firearm butt to produce a camouflage firearm butt.

10. The method of claim 1 wherein the noncamouflage material is a noncamouflage firearm foreend to produce a camouflage firearm foreend.

11. The method of claim 1 wherein the noncamouflage material is a noncamouflage unified and integrated combination firearm butt and firearm foreend to produce a unified and integrated camouflage combination firearm butt and firearm foreend.

12. The method of claim 1 wherein:
the three-dimensional digital data set is employed for making a reverse camouflage mold; and
the reverse camouflage mold is employed for molding the exterior surface of the noncamouflage material to produce the three-dimensional exterior camouflage article.

13. A camouflage article, wherein said article includes a three-dimensional exterior camouflage surface.

14. The article of claim 13 wherein said camouflage article includes an exterior surface that simulates a portion of a living organism.

15. The article of claim 14 wherein said portion of the living organism is a moth wing.

16. The article of claim 14 wherein said portion of the living organism is tree bark.

17. The article of claim 13 wherein said article includes a camouflage firearm butt.

18. The article of claim 13 wherein said article includes a camouflage firearm foreend.

19. The article of claim 13 wherein said article includes a unified and integrated camouflage combination firearm butt and firearm foreend.

20. The article produced by practicing the method of claim 1.
